(19) United States
(12) Patent Application Publication
(10) Pub. No.: US 2011/0285534 A1
(43) Pub. Date: Nov. 24, 2011

(54) REMOTE CONTROL APPARATUS USING RFID AND METHOD THEREOF

(75) Inventors: Hak Min SEO, Seoul (KR); Jae Hwan Im, Gwangmyeong (KR); Hun Park, Anyang (KR)

(73) Assignee: LSIS CO., LTD.

(21) Appl. No.: 13/101,091

(22) Filed: May 4, 2011

(30) Foreign Application Priority Data
May 20, 2010 (KR) 10-2010-0047522

(51) Int. Cl. G08B 13/14

(52) U.S. Cl. 340/572.1

(57) ABSTRACT

Disclosed is a remote control apparatus using an RFID, capable of controlling an object equipment on the basis of control information according to a user input, including a transmitter that includes a plurality of RFID tags that sends control information, to control the object equipment, selected by the user input, and a receiver that includes an RFID reader to receive the control information from the RFID tags and transfers the control information to the object equipment. There are advantages that a problem caused by using a battery in a remote controller can be solved, and a structure of the remote controller becomes simple since a function related with control information input can be mounted internally in or externally on the object equipment.

Pursuant to 35 U.S.C. §119 (a), this application claims the benefit of earlier filing date and right of priority to Korean Patent Application No. 10-2010-0047522, filed on May 20, 2010, the contents of which are hereby incorporated by reference in their entirety.

### BACKGROUND OF THE DISCLOSURE

1. Field of the Invention

The present disclosure relates to a remote control apparatus using RFID (Radio Frequency Identification) and a method thereof, and more particularly to an unpowered remote control apparatus using a passive RFID and a method thereof.

2. Description of the Related Art

RFID (Radio Frequency Identification) is a kind of AIDC (Automatic Identification and Data Capture) technology, which identifies a thin and flat-type tag attached to an object in a non-contact scheme using a radio signal and reads information therefrom.

An RFID system is basically constructed of a tag, a reader, a reader antenna and a data processing system to process data read from the tag. When an object having the tag attached thereto is located in an identification area of the reader, the reader modulates continuous electromagnetic waves having a specific frequency and sends a query signal to the tag. The tag receives the electromagnetic waves sent from the reader, processes the electromagnetic waves with back-scattering modulation and returns the modulated electromagnetic waves to the reader in order to transfer the information stored in an internal memory of a tag chip to the reader. Here, the back-scattering modulation is a method in which when a tag receives electromagnetic waves sent from the reader, scatters them and transmits the scattered electromagnetic waves to the reader again, information of the tag is sent with the scattered electromagnetic waves whose magnitude and phase are modulated.

The tag is normally constructed of a memory having data stored therein, an IC circuit, a microprocessor and an antenna, which is divided into passive and active types. The division depends on whether there exists an internal energy source or not. That is, the passive type is a type for receiving energy from a radio signal of the RFID reader so that the tag operates without any internal power source, and the active type is a type of having a built-in tag battery so that the tag operates for itself.

Meanwhile, for a short-distance area (within about 10 m) remote control scheme for appliances or industrial products, an infrared radio communication method using light is generally used. In the case of controlling objects to be controlled in more distant area or in the case that objects to be controlled are not directly visible, an RF scheme using radio waves is used. Further, a scheme using other media such as sonic waves, ultrasonic waves or magnetic line, is utilized only in a specific usage.

Currently, the most commonly used remote control scheme is to use an infrared communication method, which is constructed of a radio receiving unit connected to a TV body and a remote controller. Since the remote controller and radio receiving unit communicate wirelessly, they each need their own power sources. The radio receiving unit uses a power source provided from the TV body. However, since the remote controller is separated from the TV body, a separate power source should be provided using a battery.

As a key input of the remote controller is frequently performed by a user, battery consumption becomes larger. Further, there are inconveniences in that the battery should be frequently exchanged and it is not clear to identify the cause of connection failure to the TV body, that is, communication error or battery shortage.

### SUMMARY OF THE INVENTION

The present disclosure provides an unpowered remote control apparatus and a method thereof, wherein the apparatus is free from a separate power source by using a passive RFID.

According to an aspect of the present disclosure, a remote control apparatus using an RFID, capable of controlling object equipment on the basis of control information according to a user input, includes a transmitter that includes a plurality of RFID tags that sends control information, to control the object equipment, selected by the user input, and a receiver that includes an RFID reader to receive the control information from the RFID tags and transfers the control information to the object equipment.

According to an embodiment of the present disclosure, the transmitter may include a plurality of contact switches, and a plurality of RFID tags that are electrically connected to the plurality of contact switches, respectively, and send the control information stored in correspondence to each contact switch connected by the user input.

According to an embodiment of the present disclosure, the contact switches may be electrically connected to a plurality of input keys, respectively, the plurality of input keys being used to obtain the user input.

According to an embodiment of the present disclosure, the contact switches may be piezo-electric elements that generate electrical signals by pressure.

According to an embodiment of the present disclosure, the RFID tags may modulate RF signals that are periodically generated by the RFID reader and send the modulated signals as return signals.

According to an embodiment of the present disclosure, the RFID tags may include a power generating unit to generate driving power using the RF signal that is periodically generated by the RFID reader.

According to an embodiment of the present disclosure, the receiver may include an RFID reader that receives control information from the RFID tags; and a signal processor that converts the control information transferred by the RFID reader and transfers the converted control information to the object equipment.

According to an embodiment of the present disclosure, the receiver may

further include a synchronizer to perform synchronization between the RFID reader and the signal processor.

According to an embodiment of the present disclosure, the RFID reader may periodically generate the RF signal in order to receive the control information from the RFID tags, and transmits the control information to the signal processor when the control information is received from the RFID tags.

According to another aspect of the present disclosure, a remote control method using an RFID, capable of controlling an object equipment on the basis of control information according to a user input, including (a) sending, by an RFID reader, an RF signal periodically in order that the RFID reader receives control information from RFID tags, (b) sending, by the RFID tags, the control information according to the user input, and (c) converting, by the RFID reader, the control information received from the RFID tags and transmitting the converted control information to the object equipment.

According to an embodiment of the present disclosure, the step (b) may include sending, by the RFID tags, the control information stored in correspondence to each contact switch connected by a user input.

According to an embodiment of the present disclosure, the RFID tags may generate driving power using an RF signal that is periodically generated by the RFID reader.

According to an embodiment of the present disclosure, the contact switches may be piezo-electric elements that generate an electrical signal by pressure.

The remote control apparatus using an RFID according to the present disclosure has advantageous effects in that a problem caused by using a battery in a remote controller can be solved, and a structure of the remote controller becomes simple since a function related with control information input can be mounted internally in or externally on the object equipment.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description, serve to explain the principle of the disclosure. In the drawings:

FIG. 1 is a block diagram illustrating a construction of a remote control apparatus using an RFID according to an embodiment of the present disclosure; and

FIG2 is a flowchart illustrating a remote control method using an RFID according to an embodiment of the present disclosure.

### DETAILED DESCRIPTION OF THE PREFERRED EMBODIMENTS

Hereinafter, a preferred embodiment of the present disclosure will be described with reference to the accompanying drawings.

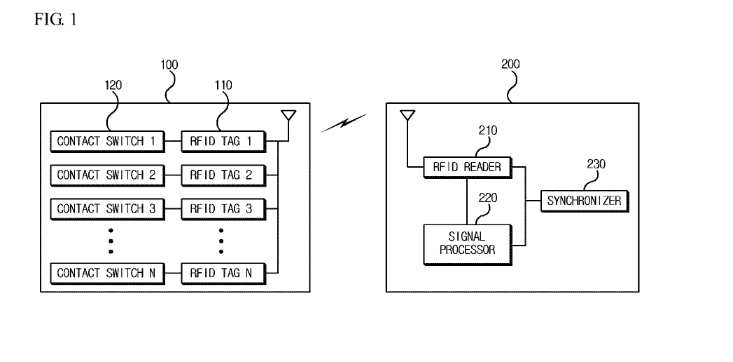

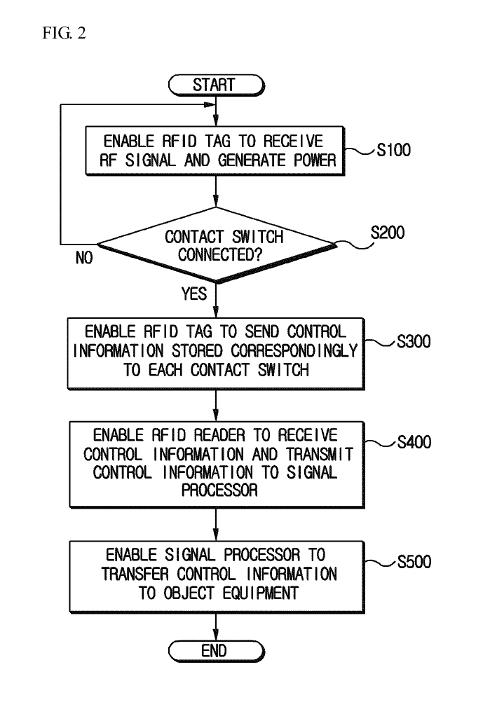

FIG. 1 is a block diagram illustrating a construction of a remote control apparatus using an RFID according to an embodiment of the present disclosure.

Referring to FIG. 1, a remote control transceiver using an RFID according to an embodiment of the present disclosure includes a remote control transmitter 100 and a remote control receiver 200.

The remote control transmitter 100 is comprised of an antenna, a plurality of RFID tags 110, and a plurality of contact switches 120. The remote control transmitter 100 may be a TV remote controller, for example.

The remote control receiver 200 is comprised of an RFID reader 210, a signal processor 220 and a synchronizer 230. The remote control receiver 200 is an apparatus connected to the TV that is mounted internally in or externally on the TV according to the standard of the TV, in order to control the TV, for example.

In the remote control transmitter 100, a TV remote controller or the like may include a plurality of input keys that are manipulated by a user. The plurality of contact switches 120 and the plurality of RFID tags 110 are connected to a plurality of input keys, respectively. That is, the plurality of input keys are connected to the plurality of contact switches 120, respectively, and the plurality of RFID tags 110 are connected to the plurality of contact switches 120, respectively.

The contact switch 120 may be a small-size piezo-electric element that generates a minute electrical signal with a pressure made by pressing the key without using any power source. That is, the contact switch is turned on by a pressure made by pressing the key and transfers a minute electrical signal generated by the pressure to the RFID tag 110.

When the RFID tag 110 receives an electrical signal from the contact switch 120 that is turned on, it sends control information stored in advance which corresponds to the input key to the RFID reader 210.

The RFID tag 110 is a passive RFID tag, which modulates RF signal transferred from the RFID reader 210 and sends a back-scattered signal, when the RFID tag 110 sends a control signal. The RFID tag 110 has control information stored previously that can be used to control the object equipment, correspondingly to each input key manipulated by a user.

Further, the RFID tag 110 is a passive RFID tag, which does not include a separate power supply apparatus. The RFID tag 110 may include a power generating unit that receives continuous RF signals generated by the RFID reader 210, rectifies the RF signals and generates a driving power. The tag antenna receiving the RF signals may include one antenna or a plurality of antennas depending on driving power to be generated.

The remote control receiver 200 may be embodied to be mounted internally in or externally on the object equipment (for example, TV set) as described above, according to an internal standard of the equipment. Therefore, the intensity of signal used between the RFID reader and the RFID tag may be modified such that the signal reaches a short distance only, whereby the signal may not interfere with neighboring other equipment.

The RFID reader 210 generates electromagnetic waves according to the predetermined number of times generating electromagnetic waves per unit time to receive valid signals and transmits the electromagnetic waves to each RFID tag 110. At the same time, the RFID reader 210 waits for a signal to be transferred from the RFID tag 110. The RFID reader 210 receives control information from the RFID tag 110 corresponding to the input key selected by a user's manipulation and transfers the control information to the signal processor 230 in synchronization with clocks of the synchronizer 230 without converting the control information.

The signal processor 220 analyzes the control information received from the RFID reader 210, converts the control information into a signal that can be identified by the object equipment and outputs it, which functions as an interface for the object equipment.

The synchronizer 230 synchronizes data when a communication is mutually performed between the RFID reader 210 and the signal processor 220.

FIG. 2 is a flowchart illustrating a remote control method using an RFID according to an embodiment of the present disclosure.

First, the RFID tags 110 that are internally mounted in input keys, respectively, receive a periodic RF signal generated from the RFID reader 210 located in the remote control receiver 200. The RFID tags 110 generate driving power by rectifying the RF signal (S100).

When the contact switch 120 is connected by a key pressing of a user (S200) and the electrical signal generated by pressure made by the key pressing is transferred to the RFID tags 110, the RFID tags 110 transmit control information stored correspondingly to each contact switch 120 (S300). At this time, the control information sent by the RFID tags 110 is a signal that is formed by modulating the RF signal received from the RFID reader 210 in magnitude and phase, the signal being returned to the RF reader 210.

When the contact switch 120 is not connected, the RFID tags 110 receive the RF signal from the RFID reader 210 and continuously generate the driving power.

Subsequently, the RFID reader 210 of the remote control receiver 200 receives the control information sent by the RFID tag 110. At this time, the RFID reader 210 generates a specified electromagnetic wave and transmits it to each RFID tags 110, and waits for a signal to be transferred from the RFID tags 110. The RFID reader 210 generates electromagnetic waves periodically according to the predetermined number of times generating the electromagnetic waves per unit time to receive a valid signal and is rendered into a state to detect a signal reception (a polling state to detect signal). When receiving a response from the RFID tag 110 in such a state, the RFID reader transmits the control information received from the RFID tag 110 to the signal processor 220 in synchronization with clocks of the synchronizer 230 (S400). The signal processor 220 analyzes the control information, converts the control information into a signal that can be identified by the object equipment (for example, TV set) and transfers the converted signal to the object equipment (S500).

Hereinbefore, while the embodiments of the present disclosure are described, they are exemplary ones only and one of ordinary skill in the art may recognize that various alterations and modifications that fall within the scope of the present disclosure may be possible. Accordingly, the true technical protection scope of the present disclosure should be defined by the following claims.

What is claimed is:

1. A remote control apparatus using an RFID, capable of controlling object equipment on the basis of control information according to a user input, the apparatus comprising:
a transmitter that includes a plurality of RFID tags that sends control information, to control the object equipment, selected by the user input; and
a receiver that includes an RFID reader to receive the control information from the RFID tags and transfers the control information to the object equipment.

2. The remote control apparatus according to claim 1, wherein the transmitter includes:
a plurality of contact switches; and
a plurality of RFID tags that are electrically connected to the plurality of contact switches, respectively, and send the control information stored in correspondence to each contact switch connected by the user input.

3. The remote control apparatus according to claim 2, wherein the contact switches are electrically connected to a plurality of input keys, respectively, the plurality of input keys being used to obtain the user input.

4. The remote control apparatus according to claim 2, wherein the contact switches are piezo-electric elements that generate electrical signals by pressure.

5. The remote control apparatus according to claim 2, wherein the RFID tags modulate RF signals that are periodically generated by the RFID reader and send the modulated signals as return signals.

6. The remote control apparatus according to claim 2, wherein the RFID tags include a power generating unit to generate driving power using the RF signal that is periodically generated by the RFID reader.

7. The remote control apparatus according to claim 1, wherein the receiver includes:
an RFID reader that receives control information from the RFID tags; and
a signal processor that converts the control information transferred by the RFID reader and transfers the converted control information to the object equipment.

8. The remote control apparatus according to claim 7, wherein the receiver further includes a synchronizer to perform synchronization between the RFID reader and the signal processor.

9. The remote control apparatus according to claim 7, wherein the RFID reader periodically generates the RF signal in order to receive the control information from the RFID tags, and transmits the control information to the signal processor when the control information is received from the RFID tags.

10. A remote control method using an RFID, capable of controlling object equipment on the basis of control information according to a user input, the method comprising:
(a) sending, by an RFID reader, an RF signal periodically in order that the RFID reader receives control information from RFID tags;
(b) sending, by the RFID tags, the control information according to the user input; and
(c) converting, by the RFID reader, the control information received from the RFID tags and transmitting the converted control information to the object equipment.

11. The remote control method according to claim 10, wherein the step (b) includes sending, by the RFID tags, the control information stored in correspondence to each contact switch connected by a user input.

12. The remote control method according to claim 10, wherein the RFID tags generate driving power using an RF signal that is periodically generated by the RFID reader.

13. The remote control method according to claim 11, wherein the contact switches are piezo-electric elements that generate an electrical signal by pressure.
